(19) United States
(12) Patent Application Publication
(10) Pub. No.: US 2026/0154560 A1
(43) Pub. Date: Jun. 4, 2026

(54) TRAINING FOR LARGE MODEL AND DATA PROCESSING METHOD

(71) Applicant: BEIJING BAIDU NETCOM SCIENCE TECHNOLOGY CO., LTD., BEIJING (CN)

(72) Inventors: Zenan LIN, BEIJING (CN); Hui LIU, BEIJING (CN); Chaoyi YUAN, BEIJING (CN); Meng SUN, BEIJING (CN); Zhongjun HE, BEIJING (CN); Xing YUAN, BEIJING (CN)

(73) Assignee: BEIJING BAIDU NETCOM SCIENCE TECHNOLOGY CO., LTD., BEIJING (CN)

(21) Appl. No.: 19/464,575

(22) Filed: Jan. 29, 2026

(30) Foreign Application Priority Data
Jun. 17, 2025 (CN) 202510813024.7

(51) Int. Cl. G06N 3/09; G06N 3/0475; G06N 3/092

(52) U.S. Cl. CPC G06N 3/09; G06N 3/0475; G06N 3/092

(57) ABSTRACT

A training method for a large model and a data processing method is provided, relating to the technical field of data processing, and particularly to artificial intelligence and large model technologies. The implementation is: determining a training sample set, where the training sample includes a pair of sample input and sample output, and the sample output includes a natural language output and a code block, where the natural language output includes a code execution result generated by the code block; providing the sample input to a large model to obtain a predicted output of the large model; and adjusting, based on the predicted output and the sample output, parameters of the large model.

### TECHNICAL FIELD

The present disclosure relates to the technical field of data processing, particularly to artificial intelligence and large model technologies, and specifically to a training method, a data processing method, an apparatus, an electronic device, a computer-readable storage medium, a computer program product, and an agent for a large model.

### BACKGROUND

Artificial intelligence is the discipline of studying how computers can simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc. The artificial intelligence software technologies mainly include computer vision technology, speech recognition technology, natural language processing technology, machine learning/deep learning, big data processing technology, knowledge graph technology and other major technological directions.

Large models in the related art are particularly adept at processing summarization and analysis tasks.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a training method for a large model, a data processing method, an apparatus, an electronic device, a computer-readable storage medium, a computer program product, and an agent.

According to an aspect of the present disclosure, a training method for a large model is provided, including: determining a training sample set, where the training sample includes a pair of sample input and sample output, and the sample output includes a natural language output and a code block, where the natural language output includes a code execution result generated by the code block; providing the sample input to the large model to obtain a predicted output of the large model; and adjusting, based on the predicted output and the sample output, parameters of the large model.

According to another aspect of the present disclosure, a large model-based data processing method is provided, where the large model is trained using the training method according to an embodiment of the present disclosure, the data processing method includes: receiving a user query, where the user query includes natural language information; and processing the user query by the large model to obtain a large model reasoning result, where the large model reasoning result is based on a natural language reasoning result and a code execution result of at least one code block generated by the large model.

According to another aspect of the present disclosure, an electronic device is provided, including: at least one processor; and a memory communicatively connected to the at least one processor; where the memory stores instructions executable by the at least one processor, and the instructions are executed by the at least one processor to enable the at least one processor to perform the method according to embodiments of the present disclosure.

According to another aspect of the present disclosure, a non-transitory computer-readable storage medium storing computer instructions is provided, where the computer instructions are used to enable the computer to perform the method according to embodiments of the present disclosure.

According to another aspect of the present disclosure, a computer program product is provided, including a computer program, where the computer program, when executed by a processor, implements the method according to embodiments of the present disclosure.

According to another aspect of the present disclosure, an agent is provided, being configured to execute the method according to embodiments of the present disclosure.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The drawings exemplarily illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein can be implemented according to embodiments of the present disclosure;

FIG. 2 illustrates an example flowchart of a training method for a large model according to an embodiment of the present disclosure;

FIG. 3 illustrates an example flowchart of a large model-based data processing method according to an embodiment of the present disclosure;

FIG. 4 illustrates an example process of a large model reasoning process according to an embodiment of the present disclosure;

FIG. 5 shows an example block diagram of a training apparatus for a large model according to an embodiment of the present disclosure;

FIG. 6 illustrates an example block diagram of a large model-based data processing apparatus according to an embodiment of the present disclosure;

FIG. 7 illustrates a structural block diagram of an example electronic device that can be used to implement embodiments of the present disclosure.

### DETAILED DESCRIPTION

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first” , “second” and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

Embodiments of the present disclosure will be described in detail below with reference to the accompanying drawings.

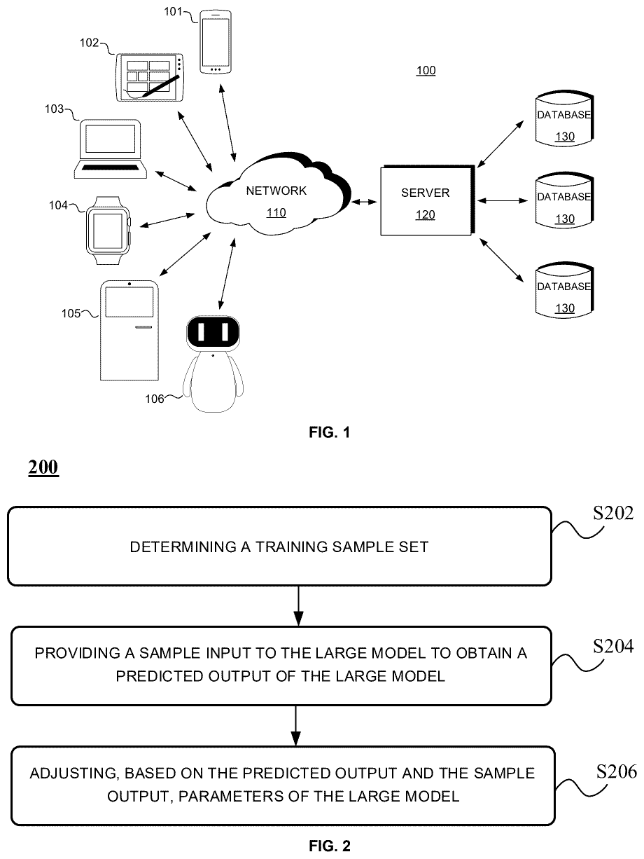

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105 and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of the methods according to the embodiments of the present disclosure.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (Saas) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to receive a user input and provide an output result to the user. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and/or 106. The server 130 may also include one or more applications to display the data feeds and/or the real-time events via one or more display devices of the client devices 101, 102, 103, 104, 105, and/or 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in a cloud computing service system to overcome the defects of management difficulty and weak service expansibility exiting in a traditional physical host and virtual private server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

The large model herein is also referred as a Large Language Model (LLM), which is a deep learning model structure with an extensive number of parameters and is trained using massive amounts of training data. An example large model is based on the Transformer model architecture. However, the model architecture of the large model is not limited to this, without departing from the principles of the present disclosure.

A large model has strong language generation capabilities and broad general task processing capabilities, as well as strong generalization capabilities, enabling it to be used to process a user query and provide an reasoning result of the model as output to assist the user in solving related problems.

However, due to the working principle of a large model relies on LLM knowledge internalization and chain of thought (COT), the capabilities of the large model are focused on summarization and analysis, and it is not well-suited for tasks that require precise computation, such as statistics, sorting, and computation. If such patterns are not present in the training dataset (e.g., pre-training, post-pre-training, supervised learning, reinforcement learning), the accuracy problem of the large model in solving such tasks is hard to tackle.

Example statistical tasks include a text statistics task, such as counting the number of characters, letters, and punctuation marks for a text given by a user. The large model tends to struggle with accurately performing such tasks, and the longer the text, the more challenging it becomes.

Example sorting tasks include a table sorting task, such as performing a sort operation on certain column of a table. When large numbers, negative numbers, multi-digit floating-point numbers, Chinese numerals, and the like are present in the table, the accuracy of the large model in performing the task may also be significantly impacted.

Example computational tasks include a table computation task, such as calculating the year-over-year change rate of one column relative to another. When multiple-digit floating-point numbers are present, such as 13.3245%, the accuracy of the large model in performing the task is also relatively low.

One reason for the above issues is that the information read by the large model during processing is highly compressed. The input information can be highly compressed into character or byte level using algorithms such as byte-pair encoding (BPE) and byte-level BPE (BBPE), such that the large model can only perceive to the token granularity, and since a token usually contains multiple characters, it is hard for the large model to have a concrete understanding of a “character”.

Additionally, the large model can not obtain time-sensitive information, such as system time. If a user requests a task to be completed X days after the current system time (e.g., a table editing task, which requires all dates in a column to be modified to X days after the current date, and the problem becomes more complex when a leap year is involved), the large model typically can not perform the task accurately.

In the related art, solutions for the above problems usually adopt two approaches: one is to use knowledge internalization during training, which improves the process capability of the large model in processing similar problems by expanding the training dataset; the other approach is to decompose the problem into multiple steps using a chain-of-thought, which improves the performance by solving the problems progressively.

However, the solutions in the related art cannot fundamentally solve the problem that it is difficult for a large model to achieve precise computation, and can only improve the solving rate of some problems.

To address the above problems in the related art, the present disclosure proposes a new solution.

FIG. 2 illustrates an example flowchart of a training method for a large model according to an embodiment of the present disclosure.

In step S202, a training sample set is determined, where the training sample includes a pair of sample input and sample output, and the sample output includes a natural language output and a code block, where the natural language output includes a code execution result generated by the code block.

In step S204, the sample input is provided to the large model to obtain a predicted output of the large model

In step S206, based on the predicted output and the sample output, parameters of the large model are adjusted.

By using the training method for the large model provided in the embodiments of the present disclosure, the large model can be trained to learn under what circumstances it is necessary to execute the code blocks on the basis of the natural language output to obtain the output result, thereby integrating the code execution into the output result of the large model and enhancing the processing capability of the large model for tasks requiring precise computation.

The principle of the present disclosure will be described in detail below.

In step S202, a training sample set is determined, where the training sample includes a pair of sample input and sample output, and the sample output includes a natural language output and code blocks, where the natural language output includes a code execution result generated by the code blocks.

Therein, the sample input may involve a statistic task, a sorting task, or a computational task. The tasks require the model to possess the capability of precise computation during the reasoning process.

In step S204, the sample input is provided to the large model to obtain a predicted output of the large model.

In step S206, based on the predicted output and the sample output, parameters of the large model are adjusted.

In some embodiments, step S202 may include generating a first training sample set for supervised learning, where the first training sample in the first training sample set is generated by: annotating a number, a position, and code content of the code blocks in the sample output; and determining an annotated training sample as the first training sample. The annotated first training sample is annotated with the code blocks that the large model should output for the sample input, and can be used for supervised learning. Using such first training sample enables the large model to learn, during reasoning, when the code blocks should be output and the appropriate content of the code blocks.

For the first training sample set for supervised learning, step S206 may include determining, based on the predicted output and the sample output, a target loss function based on supervised learning, and adjusting the parameters of the large model to minimize the target loss function. Therein, any appropriate target loss function may be selected based on actual conditions to represent the difference between the sample output and the predicted output of the model, for example, the cross-entropy function and variants thereof, and the specific form of the target loss function is not limited herein. Through the manner supervised learning, the large model is enabled to learn the output pattern of the first training sample in the first training sample set. As described above, the first training sample is annotated with the number, positions, and code content of the code blocks in the sample output, and the large model is enabled to learn, through supervised learning, under what circumstances the code should be output and what code content should be output.

In some examples, the first training sample set may further include a first noise-resistant training sample, the sample input of the first noise-resistant training sample includes noise information, and the sample output of the noise-resistant training sample includes correct code. Therein, the noise information may be incorrect content. Using the first noise-resistant training sample, the large model can be trained to generate the correct code even in the circumstance that there exists certain errors in the input information source, thereby improving the robustness of the output of the large model.

In some implementations, the sample output may include a first sub-task output and a second sub-task output, where the second sub-task output is based on the code execution result in the first sub-task output. In the case that the task problem in the sample input to be solved is relatively complex, the complex task can be decomposed into multiple sub-tasks. In an example, a complex problem may be decomposed into a flowchart formed by multiple rounds of sub-tasks using a divide-and-conquer method, and the final output result is generated through the continuous resolution of the multi-round sub-task. In this case, the predicted output obtained in step S204 may include a first sub-task predicted output and a second sub-task predicted output, where the second sub-task predicted output is based on the code execution result in the first sub-task predicted output. The target loss function for supervised learning can be determined based on the difference between the result of the first sub-task output in the sample output and the first sub-task predicted output of the large model, and the difference between the result of the second sub-task output in the sample output and the second sub-task predicted output of the large model, respectively. In this way, the large model can learn to replicate the code execution result output in the previous round, and use it for further output of the next round during the process of multi-round sub-task output.

When performing multi-round reasoning, the input data, output data, and corresponding system prompt information of all previous rounds can be concatenated when performing each new round of reasoning, for example, “Please continue to answer the question based on the computation result of the code interpreter of the previous round.”

Therein, all behavioral logic of the code of the multi-round computation is constructed based on the data of the large model, and for each sample input/each scenario, different data of multi-round computation can be determined respectively, and prompt information of different rounds can be concatenated for training.

For example, for a task of counting words in a given text, there may be only one code block in the sample output of the training sample, the code block is used to obtain the length of the given text (len), and then return the execution result and answer the question.

For another example, for a complex table understanding task, there may be multiple code blocks in the sample output of the training sample, and the question can be solved through multi-round reasoning.

In some embodiments, the step S202 may include generating a second training sample set for reinforcement learning, where the second training sample in the second training sample set includes at least one of the following:
a first positive example training sample, where the sample output includes code, and a first negative example training sample, where the sample output only includes a natural language output;
a second positive training sample, where the sample output includes correct code when the sample input does not include noise information, and a second negative training sample, where the sample output includes incorrect code when the sample input does not include noise information;
a third positive training sample, where the sample output includes correct code when the sample input includes noise information, and a third negative training sample, where the sample output includes incorrect code when the sample input includes noise information;

Using the first positive example training sample and the first negative example training sample, the trigger rate of the code output by the large model can be improved, thereby enhancing the processing capability of the large model for tasks requiring precise computation. Using the second positive example training sample and the second negative example training sample, the accuracy of the code output by the large model can be improved. Using the third positive example training sample and the third negative example training sample that contain noise information, the robustness of the output of the large model can be improved.

For the second training sample set for reinforcement learning, step S206 may include: determining, based on the sample output and the predicted output, a target reward function based on reinforcement learning; adjusting the parameters of the large model to maximize the target reward function. In an example, the target reward function may be a scalar that guides the model to maximize a cumulative reward, the scalar can determine, by combining feedbacks (e.g., a human feedback for evaluating whether the model output meets a predetermined evaluation criteria, or an evaluation model feedback), the cumulative reward of the model operation, i.e., the extent of “goodness” of the output result of the model. By maximizing the target reward function based on reinforcement learning, the model can be guided to output an output that better meets the predetermined evaluation criteria.

In some embodiments, step S202 may include generating an incorrect code reflection sample set, where the incorrect code reflection sample in the incorrect code reflection sample set include: incorrect code generated by the large model and error information corresponding to the incorrect code; and correct code for correcting the incorrect code.

In some examples, the incorrect code generated during the training of the large model can be collected, i.e., the incorrect code that generates error information in the code interpreter sandbox. Correct code for correction can be determined for the incorrect code. In some examples, the correct code can be used to replace the code content of the incorrect code, or also can be used to modify the code content of the incorrect code. In an example, the correct code can be generated by concatenating predefined prompt information (e.g., the prompt information that indicates the large model to modify the incorrect code based on the error information to generate the correct code) with the incorrect code and inputting it into the large model.

By training the large model using the incorrect code reflection sample set, the large model is enabled to have the capability to reflect on and correct the generated code. In some examples, the incorrect code reflection sample set can be used for supervised training or reinforcement training.

When performing multi-round reasoning on the large model using the training sample in the training sample set, the prompt information of the corresponding round can be concatenated in each round. Therein, the prompt information of the first round may be: If precise computation is necessary, please try to generate Python code to solve the problem. The prompt information of other rounds may be: Please continue to answer the question based on the computation result of the code interpreter of the previous round. The reflection prompt information may be: Please re-answer based on the error information of the code interpreter. The failure prompt information of the code interpreter may be: Please answer in natural language, and do not generate code.

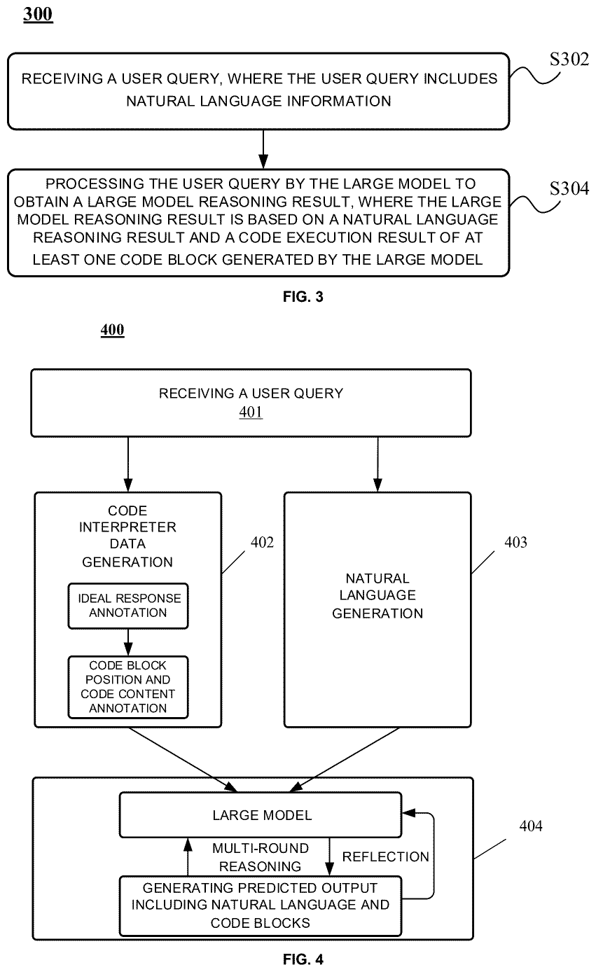

FIG. 3 illustrates an example flowchart of a large model-based data processing method according to an embodiment of the present disclosure. Where the large model used in the data processing method shown in FIG. 3 may be trained using the training method described in conjunction with FIG. 2.

In step S302, a user query is received, where the user query includes natural language information.

In step S304, the user query is processed by the large model to obtain a large model reasoning result, where the large model reasoning result is based on a natural language reasoning result and a code execution result of at least one code block generated by the large model. Therein, the large model reasoning result can be obtained by performing, according to the large model structure configured with the trained parameters, corresponding computation on the input data that includes the user query. In an example, the input of the large model may include a vectorized result of the user query in natural language form.

In some embodiments, step S304 may include: categorizing the user query to obtain a task category corresponding to the user query; determining, based on the task category, whether the large model reasoning result includes code blocks.

A trained categorization model may be utilized to categorize the user query to obtain the type of the user query. Any suitable categorization model can be used to process the user query to obtain the type of the user query, and the specific form of the categorization model is not limited herein.

Using the above method, it is possible to restrict whether the large model can interleave code blocks when performing reasoning on the input of a predetermined category by categorizing the user query.

In some implementations, the categorization model can categorize the user query according to the task type, and the example user query types may include mathematics, code, history, translation, etc. In some examples, the large model may be configured to only output code blocks for predefined input types, for example only output code blocks for mathematical type or code type inputs. It can be understood that, for the input type that can output code blocks, the large model can decide to output or not output code blocks based on an actual reasoning result. In other words, for the user query of mathematical type or code type, for example, the large model can output code blocks only when it is necessary based on the actual input content. For user queries of types that cannot output code blocks (e.g., history, translation, etc.), the large model will not output code blocks, and therefore the code output capability of the the large model will not affect tasks that do not involve precise computation.

In other implementations, the categorization model may categorize the user query based on whether code output is required, and example user query types may include code output and non-code output. In such examples, the large model will definitely output code blocks for the user query categorized as code output, and the large model will not output code blocks for the user query categorized as non-code output. Using such categorization approach will increase the trigger rate of the code output by the large model and enhance the generalization capability of the model.

In some embodiments, step S304 may include: generating a first sub-task reasoning result based on the user query, where the first sub-task reasoning result includes at least one code block and a code execution result generated by the at least one code block; generating a second sub-task reasoning result based on the code execution result in the first sub-task reasoning result; generating the large model reasoning result based on the second sub-task reasoning result.

The trained large model can decompose a complex task into a flowchart of multiple sub-tasks that include at least a first sub-task and a second sub-task, and can sequentially execute each sub-task to obtain the model reasoning result. Therein, the code execution result generated in the first sub-task reasoning result can be referenced when performing the second sub-task reasoning to further generate the second sub-task reasoning result. According to this principle, the large model can reference, in each sub-task reasoning process, the code execution result of the previous step and perform subsequent reasonings to obtain the final model reasoning result.

For example, the example user query is: Xiaowang was born in 1989, which year after reaching adulthood is the year 2025 for him? When performing reasoning on the above question using the large model, the task can be decomposed into the following sub-tasks:
the first sub-task: The year Xiaowang reached adulthood is the 18th year after his birth, and then it can be calculated that the year Xiaowang reached adulthood is 2007. Therein, the process of 1989+18=2007 is executed using the code block generated by the large model, and the code execution result of 2007 can be obtained.
the second sub-task: by computation, the result of 18 is obtained by subtracting 2007 (the year Xiao Wang reached adulthood obtained in the first sub-task) from 2025. Therein, 2007 is obtained by referencing the execution result of the first sub-task, and the process of 2025−2007=18 is executed using the code block generated by the large model.

In some examples, corresponding system prompt information may be concatenated when performing large model reasoning. For example, when performing the first round of reasoning, the example system prompt information could be: “If precise computation is necessary, you can try generating Python code to solve the problem.” By concatenating the user query and the above system prompt information using the large model, the first-round response result of the large model may include code.

In the case that the first-round response of the large model includes code, a code interpreter sandbox can be used to compute the code execution result, and concatenate the code execution result into the result of the first-round response. Subsequently, prompt information can be concatenated further to proceed to the next round of reasoning. An example prompt information could be: Please continue to answer the question based on the computation result of the code interpreter of the previous round.

By using the above method, further rounds of reasoning can be performed, and if code is further generated in subsequent reasoning round, the code interpreter sandbox can be further used to execute the code and concatenate the returned code execution result to the result of the current round response. In some examples, each time proceeding to the next round of reasoning, the input data may include all previous rounds of input data, output data, and system prompt information (please continue to answer the question based on the computation result of the code interpreter of the previous round) concatenated according to a predetermined rule. The predefined rule may be a predetermined concatenation order, and the predetermined rules are the same in the model training phase and the model reasoning phase.

The termination condition of the multi-round reasoning may include the reasoning result no longer containing code and/or reaching the maximum number of rounds.

In some embodiments, method 300 may further include: regenerating, in response to detecting error information produced when executing at least one of the code blocks generated by the large model, the code block that produced the error information.

When executing the code generated by the large model using a code interpreter sandbox, error information can be returned when an error occurs in the code, and then the large model is enabled to reflect by concatenating the system prompt information and the error information to regenerate the code. Example system prompt information includes: Please modify the code generated in the previous round based on the error information to eliminate the error information. If no error information is returned after regenerating the code, it can be considered that the code is generated correctly, and the reasoning process can continue. If the regenerated code still returns error information, the reflection process of the large model can be repeated. If error information is still returned after iterating the reflection process several times, the prompt information can be concatenated to skip the code generation. Example prompt information includes: Please answer in natural language and do not generate code, and please answer all subsequent questions directly in natural language.

By using the code reflection process described above, the large model can perform reflection on the error information of the code interpreter and guide the large model to regenerate the correct code after the reflection. The reflection process can improve the accuracy rate of the code generation of the large model.

After training the large model using the method described in conjunction with FIG. 2, the large model can learn under what circumstances the reasoning result in natural language form should be output and under what circumstances the code blocks need be interspersed in the natural language result to solve the problem.

In the case of a complex task, the large model can learn to plan the number of steps required to solve the problem and decompose the complex task into multiple sub-tasks to solve the problem. Additionally, the large model can perform reflection on the incorrect code it generates based on the reflection mechanism to regenerate the correct code.

FIG. 4 illustrates an example process of a reasoning process of a large model according to an embodiment of the present disclosure.

In step 401, a user-input query can be received. Therein, the user input can be sample input for training the large model.

In step 402, code data for training the large model can be generated. Therein, step 402 may include decomposing a complex task into multiple rounds of code generations corresponding to multiple sub-tasks respectively. Ideal response, ideal code block location and code content can be annotated in the training sample.

In step 403, natural language data for training the large model can be generated.

In step 404, the data generated in steps 402 and 403 is input into the large model. The large model processes the input data and generates corresponding predicted output. The large model can be trained using the method described in conjunction with FIG. 2. Through training, the large model can learn: (1) to plan how many steps are required to solve a problem: and distinguish under what circumstances the question should be solved in natural language and under what circumstances the code blocks should be interspersed to solve the question; (2) when performing multi-round reasoning, each round of reasoning can correctly reference the execution result of the code interpreter of the previous round and continue to answer; (3) when the code interpreter sandbox returns error information, the large model can reflect on the error information and regenerate the correct code.

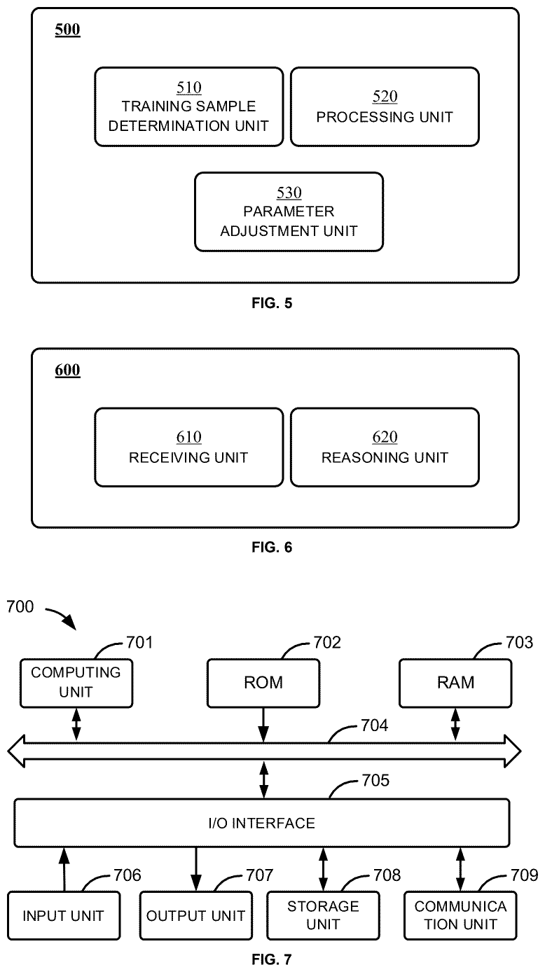

FIG. 5 illustrates an example block diagram of a training apparatus for a large model according to an embodiment of the present disclosure. The training method 200 described in conjunction with FIG. 2 can be implemented using the training apparatus described in conjunction with FIG. 5.

As shown in FIG. 5, the training apparatus 500 includes a training sample determination unit 510, a processing unit 520, and a parameter adjustment unit 530.

The training sample determination unit 510 may be configured to determine a training sample set, where the training sample includes a pair of sample input and sample output, and the sample output includes a natural language output and code blocks, where the natural language output includes a code execution result generated by the code blocks.

The processing unit 520 may be configured to provide the sample input to the large model to obtain a predicted output of the large mode. The current parameters of the large model can be utilized.

The parameter adjustment unit 530 may be configured to adjust, based on the predicted output and the sample output, parameters of the large model.

In some embodiments, the determining the training sample set includes generating a first training sample set for supervised learning, where the first training sample in the first training sample set is generated based on the following method: annotating the number, position, and code content of the code blocks in the sample output; and determining the annotated training sample as the first training sample.

In some embodiments, the first training sample set includes first noise-resistant training samples, where the sample input of the first noise-resistant training sample includes noise information, and the sample output of the noise-resistant training sample includes correct code.

In some embodiments, the sample output includes a first sub-task output and a second sub-task output, where the second sub-task output is based on the code execution result in the first sub-task output. In the case that the task problem in the sample input to be solved is relatively complex, the complex task can be decomposed into multiple sub-tasks.

In some embodiments, the predicted output includes a first sub-task predicted output and a second sub-task predicted output, where the second sub-task predicted output is based on the code execution result in the first sub-task predicted output.

In some embodiments, the adjusting, based on the predicted output and the sample output, the parameters of the large model includes: determining, based on the predicted output and the sample output, a target loss function based on supervised learning; and adjusting the parameters of the large model to minimize the target loss function.

In some embodiments, the determining the training sample set further includes generating a second training sample set for reinforcement learning, where the second training sample in the second training sample set includes at least one of the following: a first positive example training sample, where the sample output includes code, and a first negative example training sample, where the sample output only includes a natural language output; a second positive example training sample, where the sample output includes correct code when the sample input does not include noise information, and a second negative example training sample, where the sample output includes incorrect code when the sample input does not include noise information; a third positive example training sample, where the sample output includes correct code when the sample input includes noise information, and a third negative example training sample, where the sample output includes incorrect code when the sample input includes noise information;

In some embodiments, the adjusting, based on the predicted output and the sample output, the parameters of the large model includes: determining, based on the sample output and the predicted output, a target reward function based on reinforcement learning; adjusting the parameters of the large model to maximize the target reward function.

In some embodiments, the determining the training sample set includes generating an incorrect code reflection sample set, where the incorrect code reflection sample in the incorrect code reflection sample set include: incorrect code generated by the large model and error information corresponding to the incorrect code; and correct code for correcting the incorrect code. In some embodiments, the sample input involves statistical tasks, sorting tasks, or computational tasks.

It should be understood that the various modules or units of the device 500 shown in FIG. 5 may correspond to the various steps of the method 200 described with reference to FIG. 2. Accordingly, the operations, features, and advantages described above with respect to the method 200 are also applicable to the device 500 and the modules and units it includes. For the sake of brevity, certain operations, features, and advantages are not repeated here.

FIG. 6 illustrates an example block diagram of a large model-based data processing apparatus according to an embodiment of the present disclosure. The training method 300 for a large model described in conjunction with FIG. 3 can be implemented using the data processing apparatus described in conjunction with FIG. 6.

As shown in FIG. 6, the data processing apparatus 600 includes a receiving unit 610 and a reasoning unit 620.

The receiving unit 610 is configured to receive a user query, where the user query includes natural language information.

The reasoning unit is configured to process the user query by the large model to obtain a large model reasoning result, where the large model reasoning result is based on a natural language reasoning result and a code execution result of at least one code block generated by the large model.

In some embodiments, the processing the user query by the large model to obtain the large model reasoning result includes: generating a first sub-task reasoning result based on the user query, where the first sub-task reasoning result includes at least one code block and a code execution result generated by the at least one code block; generating a second sub-task reasoning result based on the code execution result in the first sub-task reasoning result; generating the large model reasoning result based on the second sub-task reasoning result.

In some embodiments, the processing the user query by the large model to obtain the large model reasoning result includes: categorizing the user query to obtain a task category corresponding to the user query; determining, based on the task category, whether the large model reasoning result includes code blocks.

In some embodiments, the reasoning unit 620 is further configured to: regenerating, in response to detecting error information produced when executing at least one of the code blocks generated by the large model, the code block that produced the error information.

It should be understood that the various modules or units of the device 600 shown in FIG. 6 may correspond to the various steps in method 300 described with reference to FIG. 3. Therefore, the operations, features, and advantages described above with respect to method 300 are also applicable to the device 600 and the modules and units it includes. In the technical solutions disclosed herein, the collection, storage, use, processing, transmission, provision, and disclosure of user personal information are in compliance with relevant laws and regulations and do not violate public order and good customs. For the sake of brevity, certain operations, features, and advantages are not repeated here.

Although specific functions are discussed above with reference to specific modules, it should be noted that the functions of the various units discussed herein may be divided into multiple units, and/or at least some functions of the multiple units may be combined into a single unit.

In the technical solutions disclosed herein, the collection, storage, use, processing, transmission, provision, and disclosure of user's personal information are in compliance with relevant laws and regulations and do not violate public order and good morals.

According to the embodiments of the present disclosure, an electronic device is provided, including: at least one processor; and a memory communicatively connected to the at least one processor; where the memory stores instructions executable by the at least one processor, and the instructions are executed by the at least one processor to enable the at least one processor to perform the method according to the embodiments of the present disclosure.

According to the embodiments of the present disclosure, a non-transitory computer-readable storage medium storing computer instructions is provided, where the computer instructions are used to cause the computer to perform the method according to the embodiments of the present disclosure.

According to the embodiments of the present disclosure, a computer program product is provided, including a computer program, where the computer program, when executed by a processor, implements the method according to the embodiments of the present disclosure.

According to the embodiments of the present disclosure, an agent is provided, being configured to execute the method according to the embodiments of the present disclosure.

Referring to FIG. 7, a structural block diagram of an electronic device 700 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 7, the electronic device 700 includes a computing unit 701, which may perform various appropriate actions and processing according to a computer program stored in a read-only memory (ROM) 702 or a computer program loaded into a random access memory (RAM) 703 from a storage unit 708. In the RAM 703, various programs and data required by the operation of the electronic device 700 may also be stored. The computing unit 701, the ROM 702, and the RAM 703 are connected to each other through a bus 704. Input/output (I/O) interface 705 is also connected to the bus 704.

A plurality of components in the electronic device 700 are connected to a I/O interface 705, including: an input unit 706, an output unit 707, a storage unit 708, and a communication unit 709. The input unit 706 may be any type of device capable of inputting information to the electronic device 700, the input unit 706 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 707 may be any type of device capable of presenting information, and may include, but are not limited to, a display, a speaker, a video/audio output terminal, a vibrator, and/or a printer. The storage unit 708 may include, but is not limited to, a magnetic disk and an optical disk. The communication unit 709 allows the electronic device 700 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 701 may be a variety of general and/or special purpose processing components with processing and computing capabilities. Some examples of the computing unit 701 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 701 performs the various methods and processes described above, such as the methods 200 and 300. For example, in some embodiments, the methods 200 and 300 may be implemented as a computer software program tangibly contained in a machine-readable medium, such as the storage unit 708. In some embodiments, part or all of the computer program may be loaded and/or installed onto the electronic device 700 via the ROM 702 and/or the communication unit 709. When the computer program is loaded to the RAM 703 and executed by the computing unit 701, one or more steps of the methods 200 and 300 described above may be performed. Alternatively, in other embodiments, the computing unit 701 may be configured to perform the methods 200 and 300 by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component(e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

What is claimed is:

1. A training method for a large model, comprising:
determining a training sample set, wherein the training sample includes a pair of sample input and sample output, and the sample output includes a natural language output and a code block, wherein the natural language output includes a code execution result generated by the code block;
providing the sample input to the large model to obtain a predicted output of the large model; and
adjusting, based on the predicted output and the sample output, parameters of the large model.

2. The training method of claim 1, wherein the determining the training sample set includes generating a first training sample set for supervised learning, wherein a first training sample in the first training sample set is generated by:
annotating a number, a position, and code content of the code block in the sample output; and
determining an annotated training sample as the first training sample.

3. The training method of claim 2, wherein the first training sample set includes a first noise-resistant training sample, wherein the sample input of the first noise-resistant training sample includes noise information, and the sample output of the first noise-resistant training sample includes correct code.

4. The training method of claim 2, wherein the sample output includes a first sub-task output and a second sub-task output, wherein the second sub-task output is based on the code execution result in the first sub-task output.

5. The training method of claim 1, wherein the predicted output includes a first sub-task predicted output and a second sub-task predicted output, wherein the second sub-task predicted output is based on the code execution result in the first sub-task predicted output.

6. The training method of claim 2, wherein the adjusting, based on the predicted output and the sample output, the parameters of the large model includes:
determining, based on the predicted output and the sample output, a target loss function based on supervised learning;
adjusting the parameters of the large model to minimize the target loss function.

7. The training method of claim 1, wherein the determining the training sample set further includes generating a second training sample set for reinforcement learning, wherein a second training sample in the second training sample set includes at least one of the following:
a first positive example training sample, wherein the sample output thereof includes code, and a first negative example training sample, wherein the sample output thereof only includes a natural language output;
a second positive training sample, wherein the sample output thereof includes correct code when the sample input does not include noise information, and a second negative training sample, wherein the sample output thereof includes incorrect code when the sample input does not include noise information;
a third positive training sample, wherein the sample output thereof includes correct code when the sample input includes noise information, and a third negative training sample, wherein the sample output thereof includes incorrect code when the sample input includes noise information;

8. The training method of claim 7, wherein the adjusting, based on the predicted output and the sample output, the parameters of the large model includes:
determining, based on the sample output and the predicted output, a target reward function based on reinforcement learning;
adjusting the parameters of the large model to maximize the target reward function.

9. The training method of claim 1, wherein the determining the training sample set includes generating an incorrect code reflection sample set, wherein the incorrect code reflection sample in the incorrect code reflection sample set includes:
incorrect code generated by the large model and error information corresponding to the incorrect code; and
correct code for correcting the incorrect code.

10. The training method of claim 1, wherein the sample input involves a statistical task, a sorting task, or a computational task.

11. A large model-based data processing method, wherein the large model is trained using the training method of claim 1, comprising:
receiving a user query, wherein the user query includes natural language information; and
processing the user query by the large model to obtain a large model reasoning result, wherein the large model reasoning result is based on a natural language reasoning result and a code execution result of at least one code block generated by the large model.

12. The data processing method of claim 11, wherein the processing the user query by the large model to obtain the large model reasoning result comprises:
generating, based on the user query, a first sub-task reasoning result, wherein the first sub-task reasoning result include at least one code block and a code execution result generated by the at least one code block;
generating, based on the code execution result in the first sub-task reasoning result, a second sub-task reasoning result;
generating, based on the second sub-task reasoning result, the large model reasoning result.

13. The data processing method of claim 11, wherein the processing the user query by the large model to obtain the large model reasoning result comprises:
categorizing the user query to obtain a task category corresponding to the user query;
determining, based on the task category, whether the large model reasoning result includes a code block.

14. The data processing method of claim 11, further comprising:
regenerating, in response to detecting error information generated when executing at least one of the code block generated by the large model, the code block that generated the error information.

15. An electronic device, comprising:
at least one processor; and
a memory communicatively connected to the at least one processor; wherein
the memory stores instructions executable by the at least one processor, the instructions are executed by the at least one processor to enable the at least one processor to perform a training method for a large model, wherein the training method comprises:
determining a training sample set, wherein the training sample includes a pair of sample input and sample output, and the sample output includes a natural language output and a code block, wherein the natural language output includes a code execution result generated by the code block;
providing the sample input to the large model to obtain a predicted output of the large model; and
adjusting, based on the predicted output and the sample output, parameters of the large model.

16. The electronic device of claim 15, wherein the determining the training sample set includes generating a first training sample set for supervised learning, wherein a first training sample in the first training sample set is generated by:
annotating a number, a position, and code content of the code block in the sample output; and
determining an annotated training sample as the first training sample.

17. The electronic device of claim 16, wherein the first training sample set includes a first noise-resistant training sample, wherein the sample input of the first noise-resistant training sample includes noise information, and the sample output of the first noise-resistant training sample includes correct code.

18. A non-transitory computer-readable storage medium storing computer instructions, wherein the computer instructions are configured to cause the computer to perform a training method for a large model, wherein the training method comprises:
determining a training sample set, wherein the training sample includes a pair of sample input and sample output, and the sample output includes a natural language output and a code block, wherein the natural language output includes a code execution result generated by the code block;
providing the sample input to the large model to obtain a predicted output of the large model; and
adjusting, based on the predicted output and the sample output, parameters of the large model.

19. The electronic device of claim 18, wherein the determining the training sample set includes generating a first training sample set for supervised learning, wherein a first training sample in the first training sample set is generated by:
annotating a number, a position, and code content of the code block in the sample output; and
determining an annotated training sample as the first training sample.

20. The electronic device of claim 19, wherein the first training sample set includes a first noise-resistant training sample, wherein the sample input of the first noise-resistant training sample includes noise information, and the sample output of the first noise-resistant training sample includes correct code.
